(19) United States
(12) Patent Application Publication
(10) Pub. No.: US 2025/0356301 A1
(43) Pub. Date: Nov. 20, 2025

(54) SYSTEM AND METHOD FOR MEASURING PERFORMANCE OF INVESTMENT

(71) Applicant: Shengli ZHAO, Beijing (CN)

(72) Inventor: Shengli ZHAO, Beijing (CN)

(21) Appl. No.: 19/085,995

(22) Filed: Mar. 20, 2025

Related U.S. Application Data
(63) Continuation of application No. PCT/CN2024/093509, filed on May 15, 2024.

(51) Int. Cl. G06Q 10/0639; G06Q 10/0635; G06Q 40/06

(52) U.S. Cl. CPC G06Q 10/06393; G06Q 10/0635; G06Q 40/06

(57) ABSTRACT

Example embodiments of the present disclosure relate to a solution for measuring performance of investment. An assessment system comprises: at least one processor; and at least one memory storing instructions that, when executed by the at least one processor, cause the system at least to: receive financial data related to two or more investments; determine a first parameter reflecting a logarithmic reward based on an initial wealth value and a terminal wealth value included in the financial data; determine a second parameter reflecting a risk based on a historical financial series between the initial and terminal time included in the financial data; determine a ratio based on the first parameter and the second parameter, the ratio being reflecting a performance of the investment; generate a comparison or ranking for the performances of the investments, based on the ratio; and select an investment to do an operation, based on the comparison or ranking.

### FIELD

Example embodiments of the present disclosure generally relate to performance measurement and in particular, to a method, a system, and a non-transitory computer readable storage medium for measuring the performance of investment and reducing a risk of financial loss based on the measured performance of the investment.

### BACKGROUND

Assessing investment performance is an important issue in finance and involves the quantitative analysis of the performances of portfolios, funds, or individual assets. Within financial markets, investors, communities, or rating agencies typically assess or appraise the performance of funds or risky (portfolio) investments and then compare or rank them. The traditional methods (measures of performance) are not objective with four general problems of observation inconsistency, leverage variance, overleverage deception, and dynamic manipulation, leading to unreasonable or ineffective performance comparison or ranking of investments, in real world. No solution yet exists to solve all, or even any three, of these technical problems. Decisions based on the traditional methods may deviate from the actual situation, leading to wrong choices in investment and ultimately financial loss.

### SUMMARY

In general, example embodiments of the present disclosure provide a solution for measuring the performance of the investment.

In a first aspect, there is provided a system. The system comprises at least one processor; and at least one memory storing instructions that, when executed by at least one processor, cause the system at least to: receive financial data related to two or more investments; determine a first parameter reflecting a logarithmic reward based on an initial wealth value and a terminal wealth value included in the financial data; determine a second parameter reflecting a risk based on a historical financial series between the initial and terminal time included in the financial data; determine a ratio based on the first parameter and the second parameter, the ratio being reflecting a performance of the investment; generate a comparison or ranking for the performances of the investments, based on the ratio; and select an investment, by an investor, to do an operation, based on the comparison or ranking.

In a second aspect, there is provided a method. The method comprises: receiving financial data related to two or more investments; determining a first parameter reflecting a logarithmic reward based on an initial wealth value and a terminal wealth value included in the financial data; determining a second parameter reflecting a risk based on a historical financial series between the initial and terminal time included in the financial data; determining a ratio based on the first parameter and the second parameter, the ratio being reflecting a performance of the investment; generating a comparison or ranking for the performances of the investments, based on the ratio; and/or selecting an investment, by an investor, to do an operation, based on the comparison or ranking.

In a third aspect, there is provided a method. The method comprises: receiving financial data related to an investment; determining a first parameter reflecting a logarithmic reward based on an initial wealth value and a terminal wealth value included in the financial data; determining a second parameter reflecting a risk based on a historical financial series between the initial and terminal time included in the financial data; determining a ratio based on the first parameter and the second parameter, the ratio being reflecting a performance of the investment; generating a warning that the performance of the investment is below a predefined threshold, based on the ratio; and reducing, by an investor, a risk of financial loss caused by the investment, based on the warning.

In a fourth aspect, there is provided a system. The system comprises at least one processor; and at least one memory storing instructions that, when executed by at least one processor, cause the system at least to: receive financial data related to an investment; determine a first parameter reflecting a logarithmic reward based on an initial wealth value and a terminal wealth value included in the financial data; determine a second parameter reflecting a risk based on a historical financial series between the initial and terminal time included in the financial data; determine a ratio based on the first parameter and the second parameter, the ratio being reflecting a performance of the investment; generate a warning that the performance of the investment is below a predefined threshold, based on the ratio; and reduce a risk of financial loss caused by the investment, based on the warning.

In a fifth aspect, there is provided a non-transitory computer readable storage medium. The non-transitory computer readable storage medium has computer executable instructions stored thereon, the instructions, when executed by a device, cause the device to perform: receive financial data related to at least two investments; determine a first parameter based on an initial wealth value and a terminal wealth value included in the financial data; determine a second parameter based on a historical financial series between the initial and terminal time included in the financial data; determine a ratio based on the first parameter and the second parameter, the ratio being reflecting a performance of the investment; a) generate a comparison or ranking for the performances of the investments, based on the ratio; and select an investment to do an operation, based on the comparison or ranking; or b) generate a warning that the performance of the investment is below a predefined threshold, based on the ratio; and reduce a risk of financial loss caused by the investment, based on the warning.

In a sixth aspect, there is provided a computer program comprising instructions, which, when executed by an apparatus, causes the apparatus at least to perform the method in the second and/or third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of function units and a network environment in which example embodiments of the present disclosure can be implemented;

FIG. 2A illustrates a process flow of method according to some embodiments of the present disclosure;

FIG. 2B illustrates a process flow of generating excess maximum drawdown compound risk (EMDD) according to some further embodiments of the present disclosure;

FIG. 2C illustrates a process flow of generating maximum excess drawdown compound risk (MEDD) according to some further embodiments of the present disclosure; and

FIG. 3 illustrates a simplified block diagram of a device that is suitable for implementing some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In the context of this disclosure, investors may use a proportion or leverage of their wealth for risky asset portfolio investments and trades. The proportion may also be referred to as leverage in a broad sense. The leverage level is normally related to the (subjective) risk preference of investors. A leverage level may be defined as the maximum (or other predefined, such as median) leverage of risky portfolio throughout the total investment.

Based on the difference in financial efficiency and leverage effect, investments may be classified into “simple” investments (additive process) or “compound” investments (multiplicative process), their rewards, risks, and performances may also be classified into the “simple” and “compound” types. Simple rewards and risks change linearly with respect to leverage level, whereas compound rewards and risks change non-linearly. Inserting or removing some “unimportant” (non-extreme) samples affects the calculation of simple measures but does not affect the calculation of compound measures. Notwithstanding a few short-term, one-period simple static investments (without trading), most long-term portfolio investments are multi-period compounds, allocating various (normally market-determined) dynamic leverages of capital to time-varying risky portfolio investment.

The classical variability, lower partial moments (LPM), value at risk (VaR), and regression-based performance measures, such as the Sharpe, Sortino, and Treynor ratios, are treated as simple measures based on (one-period or uncompounded) simple setting, yielding a view of compound investments as if they were simple investments (rewards and risks change linearly with respect to leverage level). These simple measures face three problems: 1) they yield inconsistent performance comparison and ranking between different frequencies of observation samples and trade samples; 2) they mislead investors unaware of the crash for over-leveraged investments (simple rewards keep rising without limits as leverage increases, whereas real compound rewards fall after reaching their maximum); 3) they may be dynamically manipulated by altering future leverages over time based on past performance rather than new information. These problems result in performance comparisons and rankings questionable, unreasonable, or ineffective. Furthermore, VaR and regression-based performance ratios (their risk may be either positive or negative) may change from −∞ to +∞ (or in reverse) when risk crosses 0, rendering performance comparison and/or ranking unreasonable or ineffective, as well as violating axioms of monotonicity, Fatou property, and arbitrage consistency.

The traditional drawdown-based measures, such as the MAR ratio, are treated as compound measures based on (multi-period) compound (ed) setting, having the (aforementioned) observation-inconsistent problem and a leverage-variant problem (It is challenging to counterbalance the non-linearity with respect to leverage level in the numerator and denominator of compound reward-risk ratios and satisfy the approximate compound leverage invariance).

The example embodiments of the present disclosure provide a solution for measuring performance of investment. In the example embodiments of the present disclosure, a system may receive financial data related to investments. The system may then determine a first parameter reflecting a logarithmic reward based on an initial wealth value and a terminal wealth value included in the financial data; determine a second parameter reflecting a risk based on a historical financial series between the initial and terminal time included in the financial data. The system may determine a ratio based on the first parameter and the second parameter, the ratio being reflecting a performance of the investment. The system may generate a comparison or ranking for the performances of the investments, based on the ratio. And then the system may select an investment to do an operation, based on the comparison or ranking. Moreover, the system may generate a warning that the performance of the investment is below a predefined threshold, based on the ratio. The system may reduce a risk of financial loss caused by the investment, based on the warning.

In the example embodiments of the present disclosure, the reward-risk ratio measures or evaluates investment risk-adjusted performance, using logarithmic reward as the numerator and compound risk as the denominator. In this way, the performance measure and/or performance comparison or ranking do not rely on observation frequency or unimportant samples, leverage level, overleverage deception, dynamic manipulation, and negative risk, those of which uselessly influence performance without adding value for investors and are irrelevant to the strategy of portfolio selection and timing. The method and performance of this disclosure reduce subjective bias and provide more objective results to better evaluate investments. Conscious or unconscious deception or manipulation can be prevented. This render performance comparisons and rankings more robust, coherent, equitable, objective, and less misleading, deception, or manipulation. Investment decisions based on objective performance results can increase investor confidence. By analyzing performance results, investors can develop appropriate risk management strategies. This helps reduce investment risk.

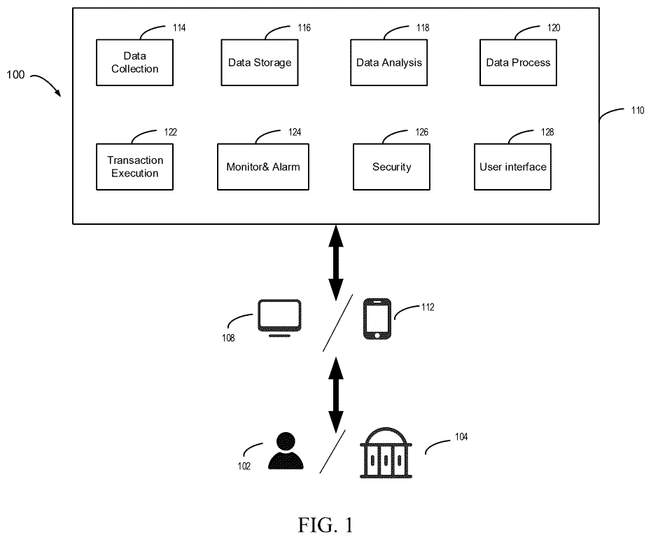

FIG. 1 illustrates an example of a network environment 100 in which example embodiments of the present disclosure can be implemented. The environment 100 may be a part of a system and comprise a plurality of devices, such as, assessment system 110, user devices or users 102, financial institutions 104, computing devices 108, and terminal devices 112, etc. It should be understood that the number and arrangement of data, objects, components, and elements shown in FIG. 1 are only examples, and the schematic figure may include different numbers and arrangements of components, elements, processing nodes, objects, and various additional elements. It should also be understood that the method implemented based on the present disclosure can also be applied to a system based on any architecture or system.

As shown in FIG. 1, the users 102 and/or financial institutions 104 may interact with the assessment system 110 implemented according to this disclosure via computing devices 108 and/or terminal devices 112. In some embodiments, the computing devices 108 and/or terminal devices 112 may be based on browser/web architecture. In some other embodiments, the computing devices 108 and/or terminal devices 112 may be based on Client/Server architecture. For example, the users 102 and/or the financial institutions 104 may log in to their accounts and view investment portfolio, account balance, transaction history, performance, risks, and other information online in the assessment system 110. Investment may include, but not limited to, an account, sub-account, super-account, or multi-accounts or non-account. In some further embodiments, the assessment system 110 may generate a report associated with the investment products of users 102 and/or financial institutions 104, and the report is related to suggestions on whether the users should increase or decrease investments based on the performance of the investment products. The investment risky assets or products may include but not limited to stocks, commodities, futures, options, funds, ETFs, FoFs, any risky securities or portfolios.

In the context of this disclosure, the users 102 may refer to individual investors who may invest in stocks, bonds, funds, such as retail investors, retail shareholders, or people who have higher wealth and make more professional investments, possibly asset allocation, risk management, etc. In some embodiments, the users 102 may include those entities who seek quick profits and typically trade within a period of time, such as speculators and/or traders. In some further embodiments, the users 102 may include those entities who provide investment advice and planning services to assist investors in making decisions, such as investment advisors and financial planners. Each type of user 102 may have different risk preferences and investments based on behaviors his/her own unique goals.

As used herein, the term “financial institution” refers to entities or organizations that engage in various financial services in the financial field. They offer a range of financial products and services to meet the financial needs of customers including individuals, businesses, and governments. These financial institutions play an important role in the financial system, supporting the flow of funds, risk management and economic activity. In some examples, the financial institutions 104 may include, but not limited to, commercial banks, investment banks, insurance companies, investment companies, hedge funds, mutual funds, FoFs, CTAs, securities companies, quantitative trading companies, trust companies, and/or pension administration, etc. Those financial institutions may provide investment and other financial services to the users 102 and the public. It is noted that the terms “investor” and “financial institution” may be used interchangeably in the context of this disclosure.

As used herein, computing devices 108 may have common capabilities such as receiving and sending data requests, real-time data analysis and process, local or remote data storage, and real-time network connections. Computing devices may generally include various types of devices. Examples of computing devices 108 may include, but are not limited to: clouds, virtual servers, database servers, rack servers, server clusters, blade servers, enterprise servers, application servers, desktop computers, notebook computers, laptops, Pads, TVs, security equipment, edge computing device, smart manufacturing equipment, smart home equipment, Internet of Things equipment, smart cars etc., this disclosure does not impose any restrictions on this.

The term “terminal device” 112 refers to a device of a communication system of a cellular or satellite network. By way of example rather than limitation, a terminal device may also be referred to as a wireless communication device, user equipment (UE). Examples of a terminal device include, but not limited to, a mobile phone, a cellular phone, a satellite phone, a smart phone, vehicle-mounted wireless terminal devices, wireless endpoints, mobile stations, laptop-embedded equipment (LEE), laptop-mounted equipment (LME), and an industrial device and applications, a consumer electronics device, a wearable device, a device operating on commercial and/or industrial wireless networks, and the like.

The assessment system 110 may comprise a plurality function modules or units, and those units work together to achieve comprehensive assessment management and operations. For example, the assessment system 110 may include data collection unit 114, and this unit is responsible for collecting various data from different sources continuously and in real time. For example, the data collection unit 114 may collect market data, including fund, stock, future, and option prices, trading volumes, exchange data, from multiple exchanges, data providers, news sources, social media opinions, and other data sources. Alternatively, or additionally, the data collection unit 114 may collect fund data from financial data providers such as Bloomberg, Morningstar, etc., fund database or data warehouse, and API interfaces provided by fund companies, exchanges, or data providers. The data collection unit 114 of the assessment system 110 may clean the collected data and remove errors, duplicate or incomplete data. The data collection unit 114 may further standardize or convert data formats into the structures required by the assessment system 110.

The data storage unit 116 of the assessment system 110 may store and manage large amounts of collected data received from the data collection unit 114. It may include a database or file, data lake, or other storage system that efficiently stores and processes historical data and provides the ability for rapid retrieval and access. For example, the data storage unit 116 may include relational database (such as MySQL, Oracle, SQL Server) or non-relational database (such as MongoDB, Cassandra) or file (such as excel, txt) to store collected data. In some embodiments, data storage unit 116 may have regular data backup mechanism ensure data security and integrity. For example, the data storage unit 116 may regularly back up data to a different location or to the cloud to prevent data loss or corruption and enable rapid recovery.

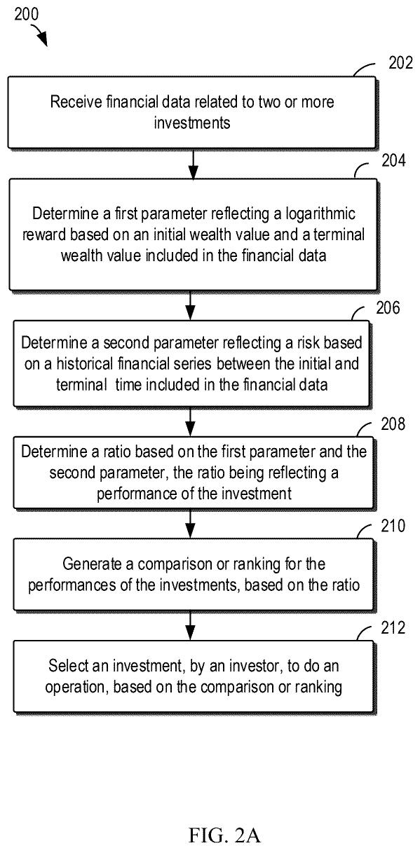

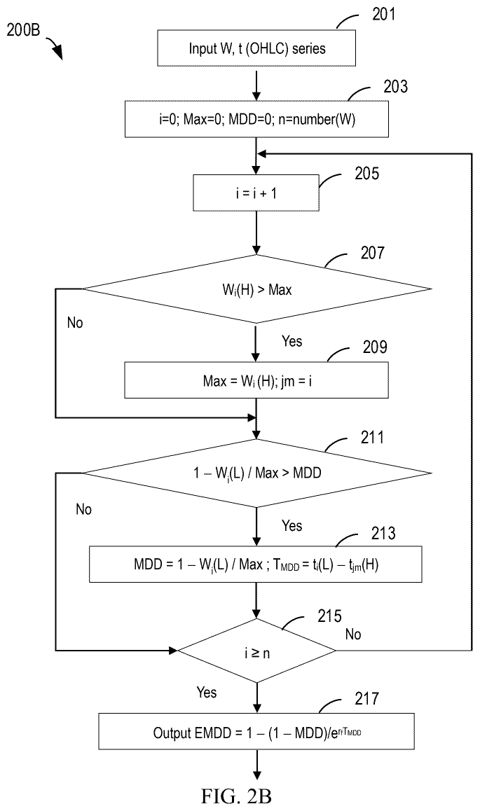

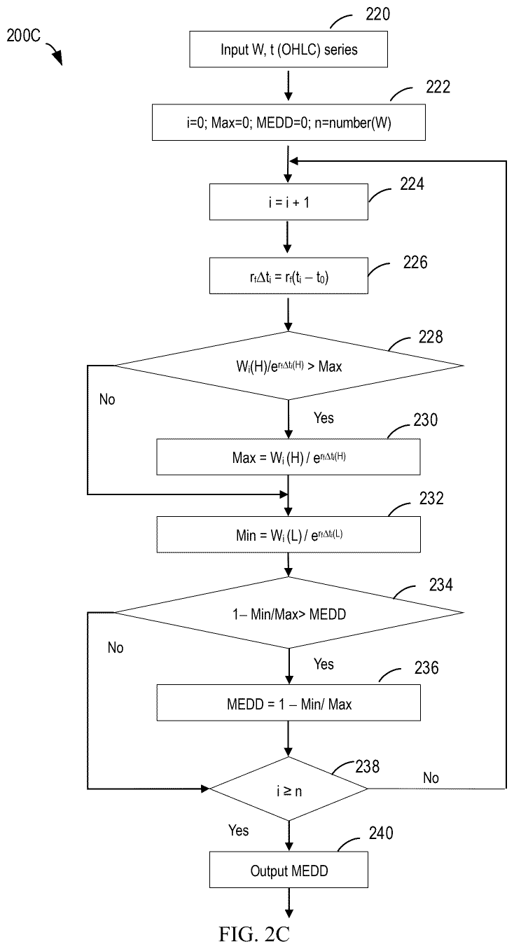

The data analysis unit 118 of the assessment system 110 may analyze the collected data. The data analysis may involve data transformation, calculation of reward, risk, and performance, technical analysis, fundamental analysis, sentiment analysis, etc. These analyzes can help investors make decisions or generate performance reports. The methods adopted by the data analysis unit 118 may be described in detail with reference to the FIGS. 2A-2C below.

In some embodiments, the reward, risk, and performance may be calculated in the data process unit 120 of the assessment system 110 and may be stored for further use. The data process unit 120 may generate a comparison for two investment performances, or generate a ranking for more (than two) investment performances by any ranking or sort algorithm, such as, quick sort, merge sort, or tree sort, etc. In some embodiments, the data process unit 120 may quickly process and update real-time data to support trading decisions. The data process unit 120 may include streaming technology, capable of processing data streams from different sources and generating real-time trading reports or instructions.

The trade execution unit 122 of the assessment system 110 may include execution algorithms, risk management systems, and trading interfaces to ensure efficient and compliant trade execution. The trade execution unit 122 may be responsible for executing trading strategies, sending orders to the exchange to open, increase, decrease, or close position for the user selected investment, and managing the execution of trades.

The user interface and visualization unit 128 of the assessment system 110 may display information to users 102 or the financial institutions 104 for viewing market data, analysis results, transaction execution, rewards, risks, performances, comparison and ranking reports, watch list, etc. The user interface and visualization unit 128 may use interactive charts, reports, dashboards, checkboxes, buttons, lists, menus, bars, sheets, panels, windows, etc. to help users better understand data and make decisions and select an investment based on the comparison or ranking reports, and then do operations, such as, view the more information of the selected investment (such as rate of return, drawdown, manager, style, etc.), mark the selected investment (such as a label, or, a tag, etc.) for further use, add the selected investment to a watch list or remove it from the watch list, award or punish the manager of the selected investment, and/or, open, increase, decrease, or close position for the selected investment, etc. In some embodiments, users 102 or the financial institutions 104 may select an investment at the first (i.e. top 1), or, the second, the third, the fourth, the fifth, . . . , the nth, etc. In some embodiments, users 102 or the financial institutions 104 may select more investments, such as top 2, top 3, top 5, top 10, . . . , top n, etc.

The monitor and alarm unit 124 of the assessment system 110 may monitor the operating status of the assessment system 110, data quality, transaction execution, etc. It may also include early warning systems that sound alerts under certain conditions to indicate possible risks or opportunities. For example, in some embodiments, the assessment system 110 may have one or more level warning indicators and corresponding one or more level thresholds. Those indicators and thresholds may be designed to gauge and signal different levels of risk or performance within the system. The users 102 or the financial institutions 104 may then input actions into the data process unit 120 based on the report, warnings, or alarm generated by the monitor and alarm unit 124.

For example, in some embodiments, when the performance of the investment for users 102 or financial institutions 104 is below the first level threshold or a low-level threshold which may signify a minor deviation or early indication of a potential issue occurs in the investment, the monitor and alarm unit 124 may generate a cautionary alert to the users 102 or the financial institutions 104 indicating a minor change or a fluctuation occurs in the investment.

In some embodiments, when the performance of the investment for users 102 or financial institutions 104 is below the second level threshold or a medium-level threshold which may signify a more substantial deviation or risk occurs in the investment, the monitor and alarm unit 124 may generate a medium-level warning to users 102 or the financial institutions 104 indicating a significant fluctuation occurs in the investment, and a certain trend or event is affecting the investment.

In some embodiments, when the performance of the investment for users 102 or financial institutions 104 is below the third level threshold or a high-level threshold which may signify a critical deviation or a substantial risk factor occurs in the investment, the monitor and alarm unit 124 may generate a high-level warning to users 102 or the financial institutions 104 indicating extreme changes associated with major events, sudden risks or crashes occur in the investment, and immediate action or emergency operations are required to input.

Alternatively, or additionally, the assessment system 110 may comprise security and permissions management unit 126, and this component may ensure the security of the system 110, including data encryption, authentication, access control and other functions, as well as functions to ensure compliance with regulatory and compliance requirements.

It is to be understood that the particular number of various devices and the particular number of various units of the assessment system 110 as shown in FIG. 1 is for illustration purposes only without suggesting any limitations. The assessment system 110 may flexibly scale up to be distributed across different countries with different units/functions on different devices and scale down to a small device and may include any suitable number of units and any suitable number of functions for implementing embodiments of the present disclosure. In addition, it should be appreciated that there may be various wireless as well as wireline communications (if needed) among all of the devices.

FIG. 2A illustrates a process flow of methods according to some embodiments of the present disclosure. For the purpose of discussion, the process flow 200 will be described with reference to FIG. 1. It would be appreciated that although the process flow 200 has been described referring to FIG. 1, this process flow 200 may be likewise applied to other similar scenarios.

In the process flow 200, at block 202, the data collection unit 114 of the assessment system 110 may receive or collect financial data related to investments. The received data may then be stored in the data storage unit 116 of the assessment system 110. The financial data may be related, but not limited to, stocks, commodities, futures, options, funds, ETFs, FoFs, any risky securities or portfolios. The investment observation period of time for the financial data may be any specific T time period (horizon), the period of time unit includes but not limited to day, week, month, quarter, year, and so on. T is positive integer or real number.

At block 204, the data analysis unit 118 of the assessment system 110 may determine a first parameter based on an initial wealth value and a terminal wealth value included in the financial data. In the context of this disclosure, the first parameter may be an excess logarithmic rate of return (ELRR), which may help the assessment system 110 to prevent overleverage deception and implement observation consistency. The first parameter may be generated anywhere or across any countries. The first parameter may be used separately. It is also noted that, in this disclosure, the risk-free rate r_{f} is a parameter in measuring performance. If the risk-free rate is not constant in the observation periods of time, the average risk-free rate r_{f} may be calculated as the risk-free compound reward of logarithmic rate of return (over the T periods), as follows:

$${r}_{f} = \frac{1}{T} ln {G}_{f} \qquad ( 1 )$$

where G_{f} is risk-free total gross rate of return.

According to the initial wealth (or net asset value) W₀ and terminal wealth (or net asset value) W_{T} included in the financial data, the assessment system 110 may calculate total gross rate of return G=W_{T}/W₀, which may help to implement observation consistency. In some embodiments, the net asset value (NAV) or asset price may be used to represent the wealth value and calculate G. In some embodiments, time-weighted rate of return (TWR) or money-weighted rate of return (MWR) may be used when external cash flow occurs. In some embodiments, the financial data may include gross rate of return G or logarithmic (gross) return lnG.

The data analysis unit 118 of the assessment system 110 may calculate the logarithmic rate of return, LRR=lnG/T. Then, it may determine the first parameter excess logarithmic rate of return ELRR relative to the risk-free rate, as follow:

$$ELRR = \frac{1}{T} ln G - {r}_{f} = \frac{1}{T} ln \frac{G}{{G}_{f}} \qquad ( 2 )$$

In some embodiments, the first parameter may be included in the financial data read by the data collection unit 114 of the assessment system 110.

At block 206, the data analysis unit 118 of the assessment system 110 may determine a second parameter based on a historical financial series between the initial and terminal time included in the financial data. In some embodiments, the second parameter may be a worst-case excess compound risk (WCECR), which possesses time separability so that may help the assessment system 110 to prevent dynamic manipulation. The second parameter may be generated anywhere or across any countries. The second parameter may be also used separately. For example, the historical financial series may be related to each year, each month, each week, each day, each trade, or other periodic or non-periodic time open(O), high(H), low(L), and close(C) wealth or net asset value series {W₀,W₁(OHLC), W₂(OHLC), . . . , Wₙ(OHLC)} and the corresponding time series {t₀,t₁(OHLC),t₂(OHLC), . . . , tₙ(OHLC)}.

In some further examples, the historical financial series may be related to each year, each month, each week, each day, each trade, or other periodic or non-periodic time (Close) end wealth (or net asset value) series {W₀, W₁, W₂, . . . , Wₙ} and time series {t₀,t₁,t₂, . . . ,tₙ}.

Calculation with OHLC series (including important extreme value information) is more accurate (closer to reality) than without, and may help the assessment system 110 to implement observation consistency. In some other examples, the data read by the data collection unit 114 of the assessment system 110 may comprise maximum drawdown (MDD) and its period of time T_{MDD}. MDD is the maximum cumulative loss from a wealth peak to the following though in percentage.

Accordingly, the data analysis unit 118 or the data process unit 120 of the assessment system 110 may determine the excess maximum drawdown compound risk EMDD compared to risk-free rate of return as the WCECR, as follow:

$$EMDD = 1 - \frac{1 - MDD}{{e}^{{r}_{f} {T}_{MDD}}} = \frac{MDD + {e}^{{r}_{f} {T}_{MDD}} - 1}{{e}^{{r}_{f} {T}_{MDD}}} \approx \frac{MDD + {r}_{f} {T}_{MDD}}{1 + {r}_{f} {T}_{MDD}} \qquad ( 3 )$$

In some further examples, the data read by the data collection unit 114 of the assessment system 110 may comprise the excess compound risk EMDD.

At block 208, the data analysis unit 118 or the data process unit 120 of the assessment system 110 may then determine a ratio based on the first parameter and the second parameter, and the ratio being reflecting a performance of the investment. For example, the data analysis unit 118 of the assessment system 110 may determine the investment performance Index_{D}, as follows:

$${Index}_{D} = \frac{ELRR}{{EMDD}^{s ign}} = \frac{\frac{1}{T} ln G - {r}_{f}}{{( 1 - \frac{1 - MDD}{{e}^{{r}_{f} {T}_{MDD}}} )}^{si gn}} \qquad ( 4 )$$

Wherein _{D} denotes the excess maximum drawdown,

$$sign = \frac{ELRR}{\vert ELRR \vert} = \frac{\frac{1}{T} ln G - {r}_{f}}{\vert \frac{1}{T} ln G - {r}_{f} \vert}$$

is the sign of ELRR.

In one embodiment of this disclosure disregarding negative performance, let sign ≡1 (≡constantly identical to); Index_{D}=0 as ELRR≤0.

In some embodiments, the data analysis unit 118 or the data process unit 120 of the assessment system 110 may determine the maximum excess drawdown compound risk MEDD compared to risk-free rate of return as the worst-case excess compound risk, as follows:

$$MEDD = {max}_{0 \leq i \leq n} \{ 1 - \frac{{w}_{i}}{{max}_{0 \leq j \leq i} {W}_{j} {e}^{{r}_{f} Δ {t}_{j , i}}} \} = {max}_{0 \leq i \leq n} \{ 1 - \frac{{w}_{i} / {e}^{{r}_{f} Δ {t}_{i}}}{{max}_{0 \leq j \leq i} {W}_{j} / {e}^{{r}_{f} Δ {t}_{j}}} \} \\ Wherein \\ {Δt}_{j , i} = {t}_{i} - {t}_{j} ; Δ {t}_{i} = {t}_{i} - {t}_{0} . \qquad ( 5 )$$

In some embodiments, the data read by the data collection unit 114 of the assessment system 110 may comprise the excess compound risk MEDD. The data analysis unit 118 or the data processing unit 120 of the assessment system 110 may then determine the investment performance Index_{ED} as follows:

$${Index}_{ED} = \frac{ELRR}{{MEDD}^{si gn}} \qquad ( 6 )$$

Where _{ED} denotes the maximum excess drawdown. In one embodiment of this disclosure disregarding negative performance, let sign≡1; Index_{ED}=0 as ELRR≤0.

At block 210, the data process unit 120 of the assessment system 110 may generate a comparison or ranking for the performances of the investments, based on the ratio. For example, the data process unit 120 of the assessment system 110 may further compare or rank investment performances, generate a list or report from big to small score (or in reverse), comprising information related to the investment's name and performance score, such as, {(fund_1:performance_1), (fund_2:performance_2), . . . , (fund_n:performance_n)}, wherein performance_1>performance_2> . . . >performance_n. The user interface and visualization unit 128 may display the comparison or ranking list or report to investors 102 or financial institutions 104.

In some embodiments, the monitor and alarm unit 124 of the assessment system 110 may generate a warning that the performance of the investment is below a predefined threshold, based on the ratio. For example, the monitor and alarm unit 124 of the assessment system 110 may generate warning comprising information related to the investment's performance decline, and potential risks. In some embodiments, the data process unit 120 of the assessment system 110 may adjust the predefined threshold based on the first parameter, the second parameter, risk preference of the investor. For example, investor's risk preference may be associated with willingness and ability to withstand fluctuations or potential losses in investor's investment portfolio in pursuit of higher returns. Additionally, or alternatively, the predefined threshold may be adjusted by the investor 102 or financial institutions 104.

The investor's risk preference may be influenced by the investor's current financial position, including income, savings, and overall wealth, investment goals including short-term goals and long-term goals like retirement, personality and emotions of the investor, knowledge and experience, and market conditions, etc.

At block 212, an investor 102 or financial institution 104 may select an investment (through the user interface unit 128) to do an operation, such as, view the more information about the selected investment; mark the selected investment; add the selected investment to a watch list or remove it from the watch list; award or punish the manager of the selected investment (with bonus/carry or without); and/or, open or increase position for the top investment, close or decrease position for the bottom investment (by the transaction execution unit 122) for the selected investment, etc., based on the comparison or ranking generated by the assessment system 110. In some examples, an investor 102 or financial institution 104 may reduce a risk of financial loss caused by the investment, based on the warning generated by the assessment system 110. The investor 102 or financial institutions 104 may adjust or re-diversify a portfolio related to the investment. For example, the investor 102 or financial institutions 104 may assess the current allocation of assets (such as stocks, bonds, cash, real estate) within the portfolio and adjust it to maintain the desired risk-return balance. The investor 102 or financial institutions 104 may also conduct periodic portfolio reviews (monthly, quarterly, annually) allowing investors to assess performance against goals, track changes in asset values, and ensure that the portfolio remains aligned with their investment risk preference.

In some embodiments, the investor 102 or financial institutions 104 may reduce positions based on the warning. For example, the investors 102 or financial institutions 104 may reduce their exposure to certain assets or their holdings in that company's stock. In some embodiments, the investors may develop a stop-loss strategy based on the warning. For example, once the warning signal reaches the predetermined threshold (as indicated by the stop-loss level), the investors may instruct the trading execution system 122 to execute the stop-loss orders to sell or withdraw some or all of the investment or the assets automatically.

In some embodiments, the investors 102 or financial institutions 104 may establish historical records related to the investment according to historical data stored in the data storage unit of the assessment system 110. In some embodiments, the assessment system 110 may provide a report related to the warning for auditing by the investor. For example, the report may include warning description which delineates the nature of the warning or signals that were identified within the assessment system, such as market conditions, technical indicators, company-specific events. The report may include the potential impacts the warning could have had on the investment portfolio or specific assets. The report may further include actions taken, such as detail the actions or decisions made in response to the warning, outcome and results describing the actual outcomes resulting from the actions taken, and compliance and regulatory compliance ensuring that the report complies with internal compliance policies and regulatory requirements.

In some embodiments, the performance of an investment may usually be evaluated in comparison with a benchmark. The benchmark may be any securities or any portfolios, such as, for example, include but not limited to, stocks, commodities, futures, funds, ETFs, Index. The superscript ^{b} and subscript _{b} may both denote benchmark.

In some embodiments, the data read by the data collection unit 114 of the assessment system 110 may comprise the benchmark initial value P₀ and terminal value P_{T} in the investment time horizon. The data analysis unit 118 or the data process unit 120 may calculate logarithmic return lnG_{b}=ln(P_{T}/P₀).

In some embodiments, the data read by the data collection unit 114 of the assessment system 110 may comprise the benchmark logarithmic return lnG_{b} in investment time horizon T. The data analysis unit 118 or the data process unit 120 may calculate logarithmic rate of return r_{b}=lnG_{b}/T.

The data analysis unit 118 or the data process unit 120 may calculate the excess logarithmic rate of return ELRR_{b} relative (compared) to benchmark logarithmic rate of return r_{b}:

$${ELRR}_{b} = \frac{1}{T} ln G - {r}_{b} = \frac{1}{T} ln \frac{G}{{G}_{b}} \qquad ( 7 )$$

In some embodiments of this disclosure, data read by the data collection unit 114 of the assessment system 110 may comprise each year, each month, each week, each day, or other periodic time benchmark price series {P₀,P₁,P₂, . . . ,Pₙ} and time series {t₀,t₁,t₂, . . . ,tₙ}. The benchmark time series correspond to the investment time series.

In some embodiments of the disclosure, the data read by the data collection unit 114 of the assessment system 110 may comprise each year, each month, each week, each day, or other periodic time benchmark gross rate of return series {G_{b}⁰,G_{b}¹,G_{b}², . . . ,G_{b}ⁿ} and time series {t₀,t₁,t₂, . . . ,tₙ}, wherein G_{b}⁰=P₀/P₀=1, G_{b}¹=P₁/P₀, G_{b}²=P₂/P₀, . . . , G_{b}ⁿ=Pₙ/P₀.

In some further embodiments of the disclosure, the Pᵢ or G_{b}ⁱ may be set instead of e^{rfΔti}, the data analysis unit 118 or the data process unit 120 of the assessment system 110 may determine the maximum excess drawdown compound risk MEDD_{b} relative (compared) to benchmark gross rate of return, as follows:

$${MEDD}_{b} = {max}_{0 \leq i \leq n} \{ 1 - \frac{{w}_{i}}{{max}_{0 \leq j \leq i} {W}_{j} Δ {G}_{j , i}} \} = {max}_{0 \leq i \leq n} \{ 1 - \frac{{W}_{i} / {P}_{i}}{{max}_{0 \leq j \leq i} {W}_{j} / {P}_{j}} \} \\ wherein \\ Δ {G}_{j , i} = {P}_{i} / {P}_{j} or Δ {G}_{j , i} = {G}_{b}^{i} / {G}_{b}^{j} . \qquad ( 8 )$$

In some embodiments of the disclosure, the data read by the data collection unit 114 of the assessment system 110 may comprise, or the data analysis unit 118 may calculate, each year, each month, each week, each day, each trade, or other periodic or non-periodic time wealth relative to benchmark gross rate of return series {W₀/P₀, W₁/P₁(OHLC), W₂/P₂(OHLC), . . . , Wₙ/Pₙ(OHLC)} and the corresponding time series {t₀,t₁(OHLC), t₂(OHLC), . . . ,tₙ(OHLC)}. In some embodiments of the disclosure, the data read by the data collection unit 114 of the assessment system 110 may comprise the excess compound risk MEDD_{b} relative (compared) to benchmark gross rate of return. The data analysis unit 118 or the data process unit 120 of the assessment system 110 may determine investment performance

$${Index}_{E D}^{b}$$

relative (compared) to benchmark gross rate of return as follows:

$${Index}_{ED}^{b} = \frac{{ELRR}_{b}}{{MEDD}_{b}^{si gn}} \qquad ( 9 )$$

Where _{ED} denotes the maximum excess drawdown, ^{b} or _{b} denotes benchmark,

$$sign = \frac{{ELRR}_{b}}{\vert {ELRR}_{b} \vert} = \frac{\frac{1}{T} ln G - {r}_{b}}{\vert \frac{1}{T} ln G - {r}_{b} \vert} is the sign of {ELRR}_{b} .$$

In some embodiments of the disclosure disregarding negative performance, let sign≡1;

$${Index}_{ED}^{b} = 0 as {ELRR}_{b} \leq 0.$$

In some further embodiments, the index or the investment performance may be

$$Index = \frac{ELRR}{{WCECR}^{si gn}} .$$

The index or ratio here and above may be named or referred to as Zhao Index.

In this way, according to this disclosure, the assessment system 110 may achieve advantages over prior arts. For example, the assessment system 110 may satisfy the observation consistency (solves the observation inconsistent problem), improve the leverage invariance (and prevents static leverage manipulations) for compounded performance measurements as against traditional drawdown-based measure systems, prevent dynamic manipulation and overleveraged deception problems as against simple measure systems, and satisfy all eight properties (axiom) for acceptability index (monotonicity, quasi-concavity, scale invariance, Fatou property, law invariance, consistency with second-order stochastic dominance, arbitrage consistency, and expectation consistency) and may be used in industrial applications.

In the prior art, the logarithmic rate of return is misunderstood because it is a monotonic transformation of the geometric average rate of return, LRR=ln(1+GARR), and therefore using the geometric average rate of return is sufficient and is no different from using the logarithmic rate of return in ranking performance. However, in fact, when measuring/evaluating/ranking the compound performance, they differ from the influence of changes in response to leverage level and time. The present disclosure may indicate and correct these misunderstandings. The use of excess logarithmic rate of return as reward and worst-case excess compound risk as risk in reward-risk ratios achieve better leverage invariant and observation consistent effect for the performance measurement.

When various funds or investments with different strategies, various leverage and risk levels, and various low-frequency, mid-frequency, and high-frequency trading are mixed together for performance measurement, evaluating, or ranking, the system of the present disclosure may more equitably, robustly, and coherently identify good investment funds or managers or strategies.

The system and method of present disclosure may be used to compare or rank investments, work as objective function (or value function) for optimization in portfolio selection and/or timing or (quantitative or artificial intelligence) investment (trading) strategy development and/or running. The optimization algorithm may include but no limited to, heuristic algorithm, genetic algorithm (GA), particle swarm optimization (PSO), simulated annealing (SA), differential evolution (DE), reinforce learning, machine learning, etc. The investment of present disclosure, may be a virtual or simulated strategy in optimization or backtest cases; may be operated by a robot or artificial intelligent agent. Strategies through optimizing or maximizing the present measures may lower the worst-case excess compound risk in strategies with a tangency portfolio on the efficient frontier and a higher ELRR. This is economical and worthwhile, with a higher reward and a lower risk and leverage level. The system and method of present disclosure may be used as subsystem in another system or sub-method in another method. The risk and reward of the system and method of present disclosure may be used independently, such as for risk control.

FIG. 2B illustrates a process flow of generating excess maximum drawdown compound risk (EMDD) according to some further embodiments of the present disclosure. As illustrated in the figure 200b, initially, at block 201, the data, such as each year, each month, each week, each day, each trade, or other periodic or non-periodic time open(O), high(H), low(L), and close(C) wealth or net asset value series {W₀,W₁(OHLC),W₂(OHLC), . . . ,Wₙ(OHLC)} and the corresponding time series {t₀,t₁(OHLC),t₂(OHLC), . . . ,tₙ(OHLC)} may be inputted into the assessment system 110. Alternatively, or additionally, in some embodiments, each year, each month, each weck, each day, each trade, or other periodic or non-periodic time end wealth (or net asset value) series {W₀, W₁, W₂, . . . , Wₙ} and time series {t₀,t₁,t₂, . . . ,tₙ} may be inputted into the assessment system 110.

At block 203, the count identifier i may be 0. The Max value may be 0, and the maximum drawdown (MDD) may be 0. The number n may be the number of the wealth series number. At block 205, the count identifier i may be incremented by one. At block 207, the assessment system 110 may determine the wealth value or net asset value Wᵢ(H) is above the Max value. At block 209, if the wealth value Wᵢ(H) is above the Max value, the Max value may equal to the wealth value Wᵢ(H), and the time identifier jₘ may be i. On the other hand, if the wealth value Wᵢ(H) is below the Max value, the assessment system 110 may move forward to block 211.

At block 211, the assessment system 110 may determine whether the difference between 1 and the ratio Wᵢ(L)/Max is above the MDD (i.e., 1−Wᵢ(L)/Max>MDD). If the difference is above the MDD, at block 213, the MDD may be 1−Wᵢ(L)/Max, and its period of time TMIDD may be tᵢ(L)−tⱼₘ(H). If the difference is below the MDD, the assessment system 110 may move forward to block 215. At block 215, the assessment system 110 may determine whether the count identifier i is equal or above number n. At block 217, if the count identifier i is equal or above number n, the assessment system 110 may output the EMDD as 1−(1−MDD)/e^{r}^{_{f}}^{T}^{_{MDD}}, wherein e is the Euler number. Otherwise, the assessment system 110 may move forward to block 205.

FIG. 2C illustrates a process flow of generating maximum excess drawdown compound risk (MEDD) according to some further embodiments of the present disclosure. As illustrated in the FIG. 200c, initially, at block 220, the data, such as each year, each month, each week, each day, each trade, or other periodic or non-periodic time open(O), high(H), low(L), and close(C) wealth or net asset value series {W₀,W₁(OHLC),W₂(OHLC), . . . ,Wₙ(OHLC)} and the corresponding time series {t₀,t₁(OHLC),t₂(OHLC), . . . ,tₙ(OHLC)} may be inputted into the assessment system 110. Alternatively, or additionally, in some embodiments, each year, each month, each week, each day, each trade, or other periodic or non-periodic time end wealth (or net asset value) series {W₀, W₁, W₂, . . . , Wₙ} and time series {t₀,t₁,t₂, . . . ,tₙ} may be inputted into the assessment system 110.

At block 222, the count identifier i may be 0. The Max value may be 0, and the MEDD may be 0. The number n may be the number of the wealth series number. At block 224, the count identifier i may be incremented by one.

At block 226, the time increment r_{f}Δtᵢ may be r_{f}(tᵢ−t₀) (i.e. r_{f}Δtᵢ=r_{f}(tᵢ−t₀)), wherein rf is the risk-free rate. At block 228, the assessment system 110 may determine whether the ratio between the wealth value or net asset value Wᵢ(H) and e^{r}^{_{f}}^{Δt}^{ᵢ}^{(H)} is above the Max value (i.e. Wᵢ(H)/e^{r}^{_{f}}^{Δt}^{ᵢ}^{(H)}>Max). At block 230, if the ratio is above the Max value, the Max value may be equal to the Wᵢ(H)/e^{r}^{_{f}}^{Δt}^{ᵢ}^{(H)}. On the other hand, if the ratio is below the Max value, the assessment system 110 may move forward to block 232.

At block 232, the assessment system 110 may determine the Min value as Wᵢ(L)/e^{r}^{_{f}}^{Δt}^{ᵢ}^{(L)}. At block 234, the assessment system 110 may determine whether the difference between 1 and Min/Max is higher than the MEDD (i.e. 1−Min/Max>MEDD). If the difference is higher than the MEDD, at block 236, the MEDD may be 1−Min/Max. If the difference is below the MEDD, the assessment system 110 may move forward to block 238.

At block 238, the assessment system 110 may determine whether the count identifier i is equal or above number n. At block 240, if the count identifier i is equal or above number n, the assessment system 110 may output the MEDD. Otherwise, the assessment system 110 may move forward to block 224. In some embodiments, the figure 200c may use Wᵢ/Pᵢ instead of Wᵢ/e^{r}^{_{f}}^{Δt}^{ᵢ} to calculate MEDD_{b}, using the data, such as each year, each month, each weck, each day, each trade, or other periodic or non-periodic time wealth relative to benchmark gross of rate return series {W₀/P₀, W₁/P₁(OHLC), W₂/P₂(OHLC), . . . , Wₙ/Pₙ(OHLC)} and the corresponding time series {t₀,t₁(OHLC), t₂(OHLC), . . . , tₙ(OHLC)}.

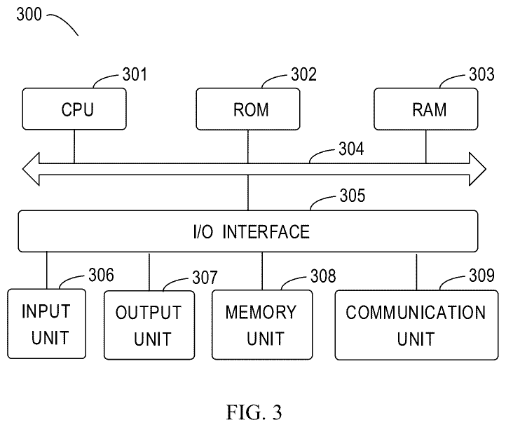

FIG. 3 illustrates a simplified block diagram of a device 300 that is suitable for implementing some example embodiments of the present disclosure. As illustrated therein, the device 300 includes a central processing unit (CPU) 301 that may perform various appropriate actions and processing based on computer program instructions stored in a Read-Only Memory (ROM) 302 or loaded from a memory unit 308 to a Random-Access Memory (RAM) 303. In the RAM 303, there may further store various programs and data needed for operations of the device 300. The CPU 301, ROM 302 and RAM 303 are connected to each other via a bus 304. An input/output (I/O) interface 305 is also connected to the bus 304.

Various components in the device 300 are connected to the I/O interface 305, including: an input unit 306 such as a keyboard, a mouse, a touch panel, and the like; an output unit 307 such as various types of displays and loudspeakers, etc.; a memory unit 308 such as a magnetic disk, an optical disk, and a flash drive, etc.; and a communication unit 309 such as a network card, a modem, and a wireless communication transceiver, etc. The communication unit 309 allows the device 300 to exchange information/data with other devices via a computer network such as the Internet/Intranet and/or various types of telecommunications networks, LAN, WAN, P2P, WIFI, Bluetooth.

The processing unit 301 may be implemented by one or more processing circuits, such as x86, ARM, MIPS, Power, Risk-V, FPGA, MCU, SoC. The processing unit 301 may be configured to perform various processes and processing described above. For example, in some embodiments, the process described above may be implemented as a computer software program that is tangibly embodied on a machine readable medium, e.g., the memory unit 308. In some embodiments, part or all of the computer program may be loaded and/or mounted onto the device 300 via ROM 302 and/or communication unit 309. When the computer program is loaded to the RAM 303 and executed by the CPU 301, one or more steps of the process as described above may be executed.

It is to be understood that although FIG. 3 is shown as an illustrative device to perform the process or method shown above, the embodiments of the present disclosure may also be implemented at one or more quantum or neural computers, the present disclosure does not limit this aspect.

The present disclosure may be implemented a system, a method and/or a computer program product. The computer program product may comprise a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM), a NOR/NAND flash, a flash drive, a hard disk drive (HDD), a solid-state drive (SSD), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosure may be assembler instructions, instruction-set-architecture (ISA) instructions, machine instructions, machine dependent instructions, microcode, firmware instructions, state-setting data, or either source code or object code written in any combination of one or more programming languages, including an programming language such as Smalltalk, C++, C, C #, Python, Java, Go, Rust, Julia, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various aspects of the disclosure.

Aspects of the disclosure are described herein with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods, and computer program products according to various embodiments of the disclosure. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A system, comprising:
at least one processor; and
at least one memory storing instructions that, when executed by the at least one processor, cause the system at least to perform acts comprising:
receiving financial data related to two or more investments;
determining a first parameter reflecting a logarithmic reward based on an initial wealth value and a terminal wealth value included in the financial data;
determining a second parameter reflecting a risk based on a historical financial series between an initial time and a terminal time included in the financial data;
determining a ratio based on the first parameter and the second parameter, the ratio reflecting a performance of an investment;
generating a comparison or ranking for performances of the investments, based on the ratio; and
selecting an investment, by an investor, to do an operation, based on the comparison or ranking;
wherein the first parameter reflecting the logarithmic reward is determined by:
$$ELRR = \frac{1}{T} ln G - {r}_{f}$$
wherein the first parameter is ELRR, G is a total gross rate of return (the terminal wealth value W_{T} divided by the initial wealth value W₀), T is a time period, and r_{f} is a risk-free rate; and
wherein the ratio is relative to a risk-free investment.

2. (canceled)

3. (canceled)

4. The system of claim 31, wherein the second parameter reflecting the risk is determined by:
$$EMDD = 1 - \frac{1 - MDD}{{e}^{{r}_{f} {T}_{MDD}}} = \frac{MDD + {e}^{{r}_{f} {T}_{MDD}} - 1}{{e}^{{r}_{f} {T}_{MDD}}} \approx \frac{MDD + {r}_{f} {T}_{MDD}}{1 + {r}_{f} {T}_{MDD}}$$
wherein the second parameter is excess maximum drawdown compound risk EMDD, MDD is maximum drawdown, and T_{MDD} is a period of time of the MDD.

5. The system of claim 4, wherein the ratio reflecting the performance of the investment is determined by:
$${Index}_{D} = \frac{ELRR}{{EMDD}^{si gn}} = \frac{\frac{1}{T} ln G - {r}_{f}}{{( 1 - \frac{1 - MDD}{{e}^{{r}_{f} {T}_{MDD}}} )}^{s ign}}$$
wherein Index_{D} is the ratio reflecting the performance of the investment relative to the risk-free rate of return, _{D} denotes the excess maximum drawdown,
$$sign = \frac{ELRR}{\vert ELRR \vert} = \frac{\frac{1}{T} ln G - {r}_{f}}{\vert \frac{1}{T} ln G - {r}_{f} \vert}$$
is the sign of ELRR; or
in response to sign≡1, ELRR≤0, Index_{D}=0.

6. The system of claim 1, wherein the second parameter reflecting the risk is determined by:
$$MEDD = {max}_{0 \leq i \leq n} \{ 1 - \frac{{W}_{i}}{{max}_{0 \leq j \leq i} {W}_{j} {e}^{{r}_{f} Δ {t}_{j , i}}} \} = {max}_{0 \leq i \leq n} \{ 1 - \frac{{W}_{i} / {e}^{{r}_{f} Δ {t}_{i}}}{{max}_{0 \leq j \leq i} {W}_{j} / {e}^{{r}_{f} Δ {t}_{j}}} \} ,$$
wherein Δt_{j,i}=tᵢ−tⱼ; Δtᵢ=tᵢ−t₀; and wherein the second parameter is maximum excess drawdown compound risk MEDD.

7. The system of claim 6, wherein the ratio reflecting the performance of the investment is determined by:
$${Index}_{ED} = \frac{ELRR}{{MEDD}^{sign}}$$
wherein Index_{ED} is the ratio reflecting the performance of the investment relative to the risk-free rate of return, _{ED} denotes the maximum excess drawdown,
$$sign = \frac{ELRR}{\vert ELRR \vert} = \frac{\frac{1}{T} ln G - {r}_{f}}{\vert \frac{1}{T} ln G - {r}_{f} \vert}$$
is the sign of ELRR; or
in response to sign≡1, ELRR≤0, Index_{ED}=0.

8. A system, comprising:
at least one processor; and
at least one memory storing instructions that, when executed by the at least one processor, cause the system at least to perform acts comprising:
receiving financial data related to two or more investments;
determining a first parameter reflecting a logarithmic reward based on an initial wealth value and a terminal wealth value included in the financial data;
determining a second parameter reflecting a risk based on a historical financial series between an initial time and a terminal time included in the financial data;
determining a ratio based on the first parameter and the second parameter, the ratio reflecting a performance of an investment;
generating a comparison or ranking for performances of the investments, based on the ratio; and
selecting an investment, by an investor, to do an operation, based on the comparison or ranking:
wherein the first parameter reflecting the logarithmic reward is determined by:
$${ELRR}_{b} = \frac{1}{T} ln G - {r}_{b} = \frac{1}{T} ln \frac{G}{{G}_{b}}$$
wherein the first parameter ELRR_{b} is an excess logarithmic rate of return (ELRR) relative to benchmark rate of return r_{b}, G_{b} is a benchmark total gross rate of return; and
wherein the performance-ratio is relative to a benchmark investment.

9. (canceled)

10. The system of claim 8, wherein the second parameter reflecting the risk is determined by:
$${MEDD}_{b} = {max}_{0 \leq i \leq n} \{ 1 - \frac{{W}_{i}}{{max}_{0 \leq j \leq i} {W}_{j} Δ {G}_{j , i}} \} = {max}_{0 \leq i \leq n} \{ 1 - \frac{{W}_{i} / {P}_{i}}{{max}_{0 \leq j \leq i} {W}_{j} / {P}_{j}} \} ,$$
wherein ΔG_{j,i}=Pᵢ/Pⱼ or ΔG_{j,i}=G_{b}ⁱ/G_{b}^{j}; and wherein the second parameter MEDD_{b} is maximum excess drawdown compound risk relative to the benchmark rate of return.

11. The system of claim 10, wherein the ratio reflecting the performance of the investment is determined by:
$${Index}_{E D}^{b} = \frac{{ELRR}_{b}}{{MEDD}_{b}^{s i g n}}$$
wherein
$${Index}_{E D}^{b}$$
is the ratio reflecting the performance of the investment relative to the benchmark rate of return, ED denotes the maximum excess drawdown,
$$sign = \frac{{ELRR}_{b}}{\vert {ELRR}_{b} \vert} = \frac{\frac{1}{T} ln G - {r}_{b}}{\vert \frac{1}{T} ln G - {r}_{b} \vert}$$
is the sign of ELRR_{b}; or
in response to sign≡1, ELRR_{b}≤0,
$${Index}_{E D}^{b} = 0 .$$

12. The system of claim 1, wherein the historical financial data comprises at least one of:
wealth OHLC value series {W₀,W₁(OHLC),W₂(OHLC), . . . ,Wₙ(OHLC)} and the corresponding time series {t₀,t₁(OHLC),t₂(OHLC), . . . ,tₙ(OHLC)}; or
wealth value series {W₀,W₁,W₂, . . . ,Wₙ} and the corresponding time series {t₀,t₁,t₂, . . . ,tₙ}; and/or
wherein the historical financial data comprises at least one of:
wealth relative to benchmark gross rate of return series {W₀/P₀, W₁/P₁(OHLC), W₂/P₂(OHLC), . . . , Wₙ/Pₙ(OHLC)} and the corresponding time series {t₀,t₁(OHLC), t₂(OHLC), . . . , tₙ(OHLC)};
benchmark price value series {P₀,P₁,P₂, . . . ,Pₙ} and the corresponding time series {t₀,t₁,t₂, . . . , tₙ}, wherein the benchmark time series correspond to the investment time series; or
benchmark gross rate of return series {G_{b}⁰, G_{b}¹, G_{b}², . . . , G_{b}ⁿ} and the corresponding time series {t₀,t₁,t₂, . . . ,tₙ}, wherein G_{b}⁰=P₀/P₀=1, G_{b}¹=P₁/P₀, G_{b}²=P₂/P₀, . . . ,G_{b}ⁿ=Pₙ/P₀.

13. The system of claim 1, wherein the operation comprises at least one of:
viewing the more information about the selected investment;
marking the selected investment;
adding the selected investment to or removing it from a watch list;
award or punish the manager of the selected investment; or
opening, increasing, decreasing, or closing position for the selected investment.

14. The system of claim 1, wherein the ratio is used to:
work as objective function for optimization in portfolio selection and/or timing; or
facilitate quantitative or artificial intelligence trading strategy development and/or running.

15. A computer-implemented method, comprising:
receiving financial data related to two or more investments;
determining a first parameter reflecting a logarithmic reward based on an initial wealth value and a terminal wealth value included in the financial data;
determining a second parameter reflecting a risk based on a historical financial series between an initial time and a terminal time included in the financial data;
determining a ratio based on the first parameter and the second parameter, the ratio reflecting a performance of an investment;
generating a comparison or ranking for performances of the investments, based on the ratio; and
selecting an investment, by an investor, to do an operation, based on the comparison or ranking;
wherein the first parameter reflecting the logarithmic reward is determined by:
$$ELRR = \frac{1}{T} ln G - {r}_{f}$$
wherein the first parameter is ELRR, G is a total gross rate of return (the terminal wealth value W_{T} divided by the initial wealth value W₀), T is a time period, and r_{f} is a risk-free rate, and
wherein the ratio is relative to a risk-free investment;
or
wherein the first parameter reflecting the logarithmic reward is determined by:
$${ELRR}_{b} = \frac{1}{T} ln G - {r}_{b} = \frac{1}{T} ln \frac{G}{{G}_{b}}$$
wherein the first parameter ELRR_{b} is an excess logarithmic rate of return (ELRR) relative to benchmark rate of return r_{b}, G_{b} is a benchmark total gross rate of return, and wherein the ratio is relative to a benchmark investment.

16. A system, comprising:
at least one processor; and
at least one memory storing instructions that, when executed by the at least one processor, cause the system at least to:
receive financial data related to an investment;
determine a first parameter reflecting a logarithmic reward based on an initial wealth value and a terminal wealth value included in the financial data;
determine a second parameter reflecting a risk based on a historical financial series between an initial time and a terminal time included in the financial data;
determine a ratio based on the first parameter and the second parameter, the ratio reflecting a performance of an investment;
generate a warning that the performance of the investment is below a predefined threshold at least one warning indicator from multiple-level warning indicator, based on the ratio; and
reduce, by an investor, a risk of financial loss caused by the investment, based on the at least one warning indicator;
wherein the first parameter reflecting the logarithmic reward is determined by:
$$ELRR = \frac{1}{T} ln G - {r}_{f}$$
wherein the first parameter is ELRR, G is a total gross rate of return (the terminal wealth value W_{T} divided by the initial wealth value W₀), T is a time period, and r_{f} is a risk-free rate, and
wherein the ratio is relative to a risk-free investment;
or
wherein the first parameter reflecting the logarithmic reward is determined by:
$${ELRR}_{b} = \frac{1}{T} ln G - {r}_{b} = \frac{1}{T} ln \frac{G}{{G}_{b}}$$
wherein the first parameter ELRR_{b} is an excess logarithmic rate of return (ELRR) relative to benchmark rate of return r_{b}, G_{b} is a benchmark total gross rate of return, and wherein the ratio is relative to a benchmark investment.

17. The system of claim 16, wherein the warning indicator comprises information related to the investment's performance decline, and potential risks; and
wherein the predefined threshold is adjusted based on a first parameter, a second parameter, and a risk preference of the investor.

18. The system of claim 16, wherein reducing the risk of financial loss caused by the investment comprises performing at least one of:
adjusting or re-diversifying a portfolio related to the investment,;
reducing positions;
developing a stop-loss strategy;
withdrawing some or all of the investment;
establishing historical records related to the investment; or
providing a report related to the warning for auditing.

19. The system of claim 16, wherein the system is caused to generate a warning that the performance of the investment is below a predefined threshold, based on the ratio, wherein the predefined threshold includes a first level threshold, a second level threshold, a third level threshold, and wherein generating the warning comprises:
upon determining that the performance of the investment is below the first level threshold, generating the warning indicating a minor change or a fluctuation occurs in the investment;
upon determining that the performance of the investment is below the second level threshold, generating the warning indicating a significant fluctuation occurs in the investment, and a certain trend or event is affecting the investment; and
upon determining that the performance of the investment is below the third level threshold, generating the warning indicating an extreme change associated with major events, sudden risks or crashes occurs in the investment, and immediate action or emergency measures are required to input.

20. (canceled)

21. The system of claim 8, wherein the historical financial data comprises at least one of:
wealth OHLC value series {W₀,W₁(OHLC),W₂(OHLC), . . . ,Wₙ(OHLC)} and the corresponding time series {t₀,t₁(OHLC),t₂(OHLC), . . . ,tₙ(OHLC)}; or
wealth value series {W₀,W₁,W₂, . . . ,Wₙ} and the corresponding time series {t₀,t₁,t₂, . . . ,tₙ}; and/or
wherein the historical financial data comprises at least one of:
wealth relative to benchmark gross rate of return series {W₀/P₀, W₁/P₁(OHLC), W₂/P₂(OHLC), . . . ,Wₙ/Pₙ(OHLC)} and the corresponding time series {t₀,t₁(OHLC),t₂(OHLC), . . . , tₙ(OHLC)};
benchmark price value series {P₀,P₁,P₂, . . . ,Pₙ} and the corresponding time series {t₀,t₁,t₂, . . . , tₙ}, wherein the benchmark time series correspond to the investment time series; or
benchmark gross rate of return series {G_{b}⁰,G_{b}¹,G_{b}², . . . ,G_{b}ⁿ} and the corresponding time series {t₀,t₁,t₂, . . . ,tₙ}, wherein G_{b}⁰=P₀/P₀=1, G_{b}¹=P₁/P₀, G_{b}²=P₂/P₀, . . . , G_{b}ⁿ=Pₙ/P₀.

22. The system of claim 8, wherein the operation comprises at least one of:
viewing the more information about the selected investment;
marking the selected investment;
adding the selected investment to or removing it from a watch list;
award or punish the manager of the selected investment; or
opening, increasing, decreasing, or closing position for the selected investment.

23. The system of claim 8, wherein the ratio is used to:
work as objective function for optimization in portfolio selection and/or timing; or
facilitate quantitative or artificial intelligence trading strategy development and/or running.
